(19) United States
(12) Patent Application Publication
(10) Pub. No.: US 2026/0087439 A1
(43) Pub. Date: Mar. 26, 2026

(54) METHOD AND SYSTEM FOR AI-ENABLED CHARACTERIZATION OF PERFORMANCE AND APPLICATIONS THEREOF

(71) Applicant: Verizon Patent and Licensing Inc., Basking Ridge, NJ (US)

(72) Inventors: Nilanjan Das Khan, Bangalore (IN); Tushar Singh, Bangalore (IN); Goutham Kumar Chikoti, Hyderabad (IN); R Vishnu, Bangalore (IN)

(73) Assignee: Verizon Patent and Licensing Inc., Basking Ridge, NJ (US)

(21) Appl. No.: 18/894,438

(22) Filed: Sep. 24, 2024

(51) Int. Cl. G06Q 10/0639; G06F 40/166; G06F 40/35; G06Q 10/0631

(52) U.S. Cl. CPC G06Q 10/06398; G06F 40/166; G06F 40/35; G06Q 10/063112

(57) ABSTRACT

The present teaching relates to AI-enabled characterization of agent performance. Transcripts of historic communications between agents and customers are analyzed by AI-enabled models to generate historic agent features to characterize agents'historic performance. When a new communication associated with an intent is initiated, candidate agents are identified according to the intent and their historic agent features. Current dynamics of each candidate agent are determined via AI-enabled models. A matching agent is selected based on the historic agent features and current dynamics of the candidate agents so that the new communication is directed to the matching agent.

### BACKGROUND

Today, companies offering different services compete not only on the quality of their respective services but also on the quality of care to their customers. For example, a customer may raise questions about a service received, inquire about a charge associated with a service, or report some problems encountered during a service. To enhance satisfaction on customer services, service providers provide appropriate infrastructure with platforms/means accessible to their customers to facilitate customer/provider communications. For example, an interactive voice response (IVR) system may be deployed with a group of agents connected thereto to support customers. Through this platform, a customer may present a question/concern/issue, and the platform may either automatically retrieve an answer previously stored or match the customer with an agent who is selected, according to some criteria, to address the customer's question/concern/issue.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates an exemplary framework of applying generative artificial intelligent (AI) enabled agent feature characterization in automated customer/agent matching, in accordance with an exemplary embodiment of the present teaching;

FIG. 1B shows exemplary types of agent features for characterizing an agent, in accordance with an exemplary embodiment of the present teaching;

FIG. 2A is a flowchart of an exemplary process of obtaining historic agent features based on historic communication records, in accordance with an embodiment of the present teaching;

FIG. 2B is a flowchart of an exemplary process of identifying a matching agent based on both historic features and current dynamics of the agent, in accordance with an embodiment of the present teaching;

FIG. 3A depicts an exemplary high level system diagram of an AI-enabled agent feature detector, in accordance with an embodiment of the present teaching;

FIG. 3B is a flowchart of an exemplary process for generating historic agent features, in accordance with an embodiment of the present teaching;

FIG. 3C is a flowchart of an exemplary process for evaluating current agent dynamics of an agent, in accordance with an embodiment of the present teaching;

FIG. 4A depicts a flow of operation to obtain embeddings representing an agent's problem-solving proficiency, in accordance with an embodiment of the present teaching;

FIG. 4B illustrates an example of obtaining embeddings characterizing an agent's problem-solving proficiency, in accordance with an embodiment of the present teaching;

FIG. 4C depicts a flow of operation to obtain embeddings representing an agent's behavioral skills, in accordance with an embodiment of the present teaching;

FIG. 4D illustrates an example of obtaining embeddings characterizing an agent's behavioral skills, in accordance with an embodiment of the present teaching;

FIG. 4E depicts a flow of operation to obtain embeddings representing an agent's sale quotient, in accordance with an embodiment of the present teaching;

FIG. 4F illustrates an example of obtaining embeddings characterizing an agent's sale quotient, in accordance with an embodiment of the present teaching;

FIG. 4G depicts a flow of operation to obtain embeddings representing an agent's current dynamics, in accordance with an embodiment of the present teaching;

FIG. 5A depicts an exemplary high level system diagram of an agent-feature embedding generator, in accordance with an embodiment of the present teaching;

FIG. 5B is a flowchart of an exemplary process of an agent-feature embedding generator, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Customers often communicate with their service providers on different questions/issues/concerns. Service providers make efforts to facilitate such communications in order to enhance customer satisfaction. For example, call centers may be established with agents residing therein to provide 24/7 accessibility to customers. In more recent years, more cost-effective means have also emerged, such as IVR systems and online chatbots. Despite such effort to automate the communication with customers, in some situations, such less labor-intensive systems may not be able to resolve all customer issues. When that happens, such systems may direct the ongoing communications to human agents.

Challenges exist in such redirection process, including appropriately pairing customers with suitable agents to handle specific inquiries or issues. Traditionally, a redirection process relies on either manual assignments or some rudimentary pairing/ranking algorithms that operate based on limited set of observable/recorded performance indicators. As such, these traditional approaches frequently result in misaligned or suboptimal customer-agent pairings. For example, when the intent of a customer's call or agent's strength/weakness in relevant categories are not well understood, a misalignment may occur. The simplicity of such rudimentary evaluation schemes (usually with merely a ranking) in traditional solutions likely leads to sub-optimal pairings. Such misalignment and sub-optimality yield prolonged call durations and, hence, increased customer anxieties and reduced customer satisfaction. In addition, although customer communications often present an upsell opportunity, such opportunities are often not recognized, let alone utilized in pairing in a traditional system.

The present teaching discloses a scheme in which AI-enabled models are trained based on transcripts of historic communications and leveraged to capture various performance related features associated with a task executor, which may be an agent or a network component or a system, to characterize the task executor's capability/performance in different relevant aspects. Such performance related features may characterize both historic performance and near real-time dynamics of a task executor and may be used to pair the task executor with another party in need of assistance so that both known performance (historic) and the recent ability to perform (current dynamics) can be considered to obtain an optimal pairing.

In some embodiments, AI-enabled models employed for different analytics may include language models for analyzing textual information to obtain meaningful features characterizing performance of a task such as agent's communication with customers based on transcripts of their conversations. Language models may be either a large language model (LLM) or a small language model (SLM), which may be employed based on application needs. In some applications, an SLM may be adopted in a transformer architecture with a multi-head attention layer, which may be appropriate for a situation where domain-specific knowledge may be implicated. Using an SLM may improve the efficiency and capability in fine-tuning application-specific tasks and such an SLM may be custom trained using relevant datasets related to the multiple targeted tasks. In some embodiments of the present teaching, a custom SLM model may be trained to obtain an analytical engine for producing a summary of a document, another may be trained for determining metrics based on text information to characterize some defined aspects of the performance of a task executor. Features derived via AI-enabled models according to the present teaching characterize performance of a task executor with respect to separate aspects of the task based on textual information, which may be obtained from, e.g., communications (textual or voice) or records of operations (logs of network components). The AI enabled performance characterization may have different applications. For example, pairing customers with appropriate agents as discussed herein. Another example application is earlier detection of causal reasons related to some aspect of performance (e.g., lack of communication skill) associated with some target event (e.g., customer churn) based on features previously modeled related to the aspect to enable preventative measures. Although there are different applications, the following disclosure is provided based on the application of pairing a customer (party in need) with an agent (task executor) based on agent's features obtained via AI-enabled models obtained according to communications (past and present) involving the agent. It is understood that the disclosure provided in this exemplary application is merely for illustration rather than as a limitation. The disclosed scheme of obtaining, via AI-enabled models, enriched historic and dynamic features in relation to different aspects of an agent's performance may be applied in any other suitable applications to evaluate a task executor to facilitate the pairings between tasks executors and parties in need.

In the context of pairing customers and agents, features obtained via AI-enabled models may characterize an agent's capability/performance with respect to different aspects in assisting customers. Such features include ones that characterize an agent's historic performance and ones that indicate the agent's current performances. The historic features may characterize the agent's problem-solving proficiency associated with different types of inquiries, the agent's skills in communicating with customers in terms of patience, behavior, etc., and the agent's ability to, e.g., take the opportunity to recommend other services to customers to expand the businesses. The current dynamics reflect the agent's near real-time state and represent the agent's current performance.

AI-enable models may be obtained to create content in response to inquiries. Such AI generated content may include answers to questions (e.g., describe attractions in Chicago), summaries generated based on input texts (e.g., a summary of an article), psychometrics (e.g., a metric about communication clarity) measured based on communication content, and analytics directed to some specified quality (e.g., multi-lingual ability), etc. The present teaching leverages different AI-enabled analytical engines to obtain assessments on different dimensions of an agent's performance and utilizes such assessments to derive characterizations (e.g., embeddings) representing the agent's ability/performance in respective aspects. For example, depending on application needs, an agent may be characterized in terms of the problem-solving proficiency with respect to different categories of issues that customers may have. An agent may be evaluated in terms of communication skills, including whether possessing multi-lingual capability, providing clarity in communication, being patient and empathetic, the ability to compliant with policies, etc. An agent's communications may also be assessed via AI-enabled models to evaluate the agent's negotiation skills, the ability of capturing the opportunity to upsell and/or cross-sell, the agent's personality, and even the sales'amount materialized. The evaluation from past communication transcripts may then be utilized to develop representations (e.g., embeddings) of different qualities for each agent when, e.g., the agent is considered in pairing. For instance, an agent may be skilled in resolving issues related to billing complaints but may not be that skilled in dealing with inquiries on technical problems. With that characterization, a customer's call on billing issues may be matched with an agent who is known to be skilled in billing related issues.

Pairing customers with agents according to the present teaching may consider also the current (near real-time) state of agents because a strong historic performance does not necessarily correspond to good performance at a present time. An evaluation of the current dynamics may also be achieved via AI-enabled models based on communications involving the agent in a recent period (e.g., in one day) in addition to the evaluation of the historic performance. An agent's dynamics may be evaluated in terms of whether the agent seems exhausted or emotional and customers in recent communications appear to be upset or satisfied, etc. The evaluation of recent states of agents may affect, in combination with the evaluation on their historic performance, how agents may be matched with customers with different inquiries.

As discussed herein, in addition to the exemplary IVR application to automatic redirect customers to suitable agents, the AI-enabled approach as discussed herein to obtain characterization of performance may also be applied to other applications. For instance, it may be applied to matching a distributed network component to perform a requested task based on past and recent performance records. Logs on input requests for operations performed by distributed network components as well as on outcomes thereof may be analyzed using AI-enabled models to evaluate the performance with respect to specified aspects. When a next input request is received to perform a task, a network component may be matched to perform the task based on the evaluation. Another example application of the present teaching is to leverage the AI-enabled evaluation of certain aspect of performance (e.g., upselling as discussed herein) in coaching other agents how to improve their performance in the same aspect (e.g., enhance upselling probabilities). Yet another exemplary application of the present teaching is for earlier detection of customers'churning propensity based on indicators associated therewith captured via AI-enabled models based on communications between customers and agents. Earlier detection of such indicators may be leveraged to develop customized recommendations directed to the specific indicators associated with each customer to prevent churning.

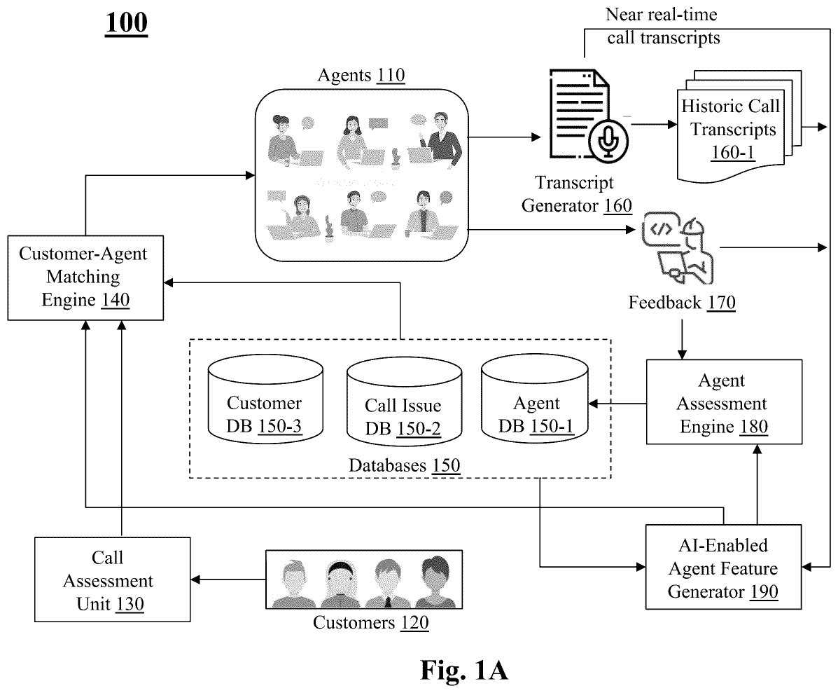

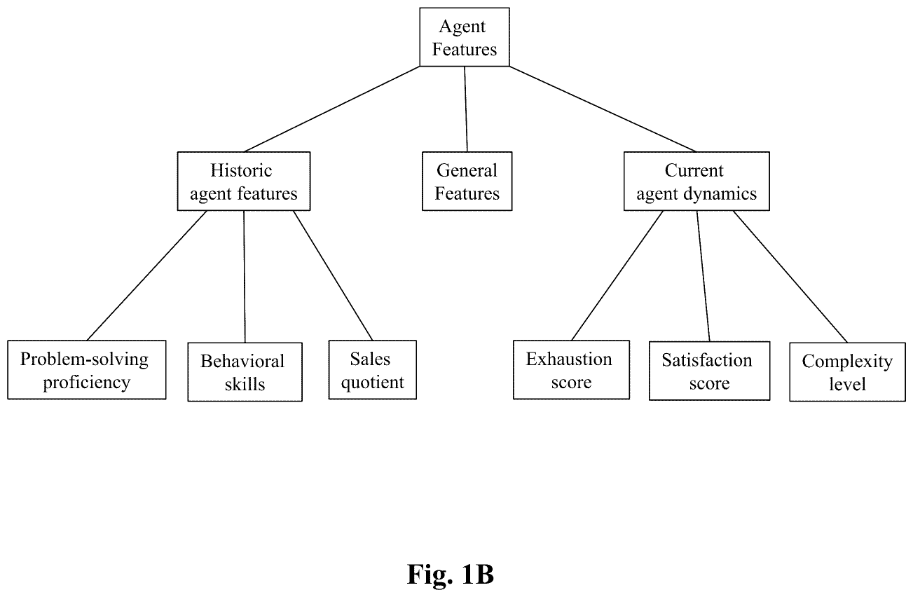

FIG. 1A illustrates an exemplary framework 100 of applying AI-enabled agent feature characterization in automated customer/agent matching, in accordance with an exemplary embodiment of the present teaching. The exemplary framework 100 comprises agents 110, customers 120, a frontend for matching a customer call with a suitable agent, and a backend for creating information in databases 150 to facilitate the matching based on communications between customers and agents. The frontend includes a call assessment unit 130 and a customer-agent matching engine 140. The databases 150 include, e.g., an agent databased 150-1, a call issue database 150-2, and a customer database 150-3. The backend includes a transcript generator 160, a mechanism for creating feedback 170 (e.g., a log system for managerial personnel to provide feedback on agents'performance), an AI-enabled agent feature generator 190, and an agent assessment engine 180.

The call assessment unit 130 may be provided for initially interfacing with customers on calls to determine customer intent, e.g., assess what customer calls are about (e.g., billing issue, service issue, etc.), and forwarding the assessment to the customer-agent matching engine 140. In some implementations, the call assessment unit 130 may correspond to an IVR system which may be configured to automatically communicate with customers on their inquiries and provide responses whenever it can and then hand the calls to the customer-agent matching engine 140 when the calls required human agents'involvement with its assessment on the issues of the calls. The customer-agent matching engine 130 may be provided for matching a customer with a suitable agent according to the issue involved in a call from the customer based on information stored in databases 150. The appropriateness of the matching may depend on the knowledge about the agents considering the issue. In some situations, the matching may also consider known properties of the customer. The knowledge about the agents may be represented in the agent database 150-1 and is derived based on AI-enabled performance evaluation according to the present teaching.

The AI-enabled agent feature generator 190 may be provided to obtain features for the agents 110 to characterize their performance with respect to different qualifying dimensions. FIG. 1B shows exemplary types of features for characterizing an agent, in accordance with an exemplary embodiment of the present teaching. As illustrated, agent features may include general features, historic agent features, and current agent dynamics. General agent features may specific generic information about an agent such as name, position, years on the job, overall rating on performance, etc.

Historic agent features and current agent dynamics may be provided to characterize an agent's performance on the job with respect to different timeframes and different aspects. The historic performance may be evaluated based on past communications with different customers to derive historic features. As shown in FIG. 1B, exemplary historic features representing the capability and performance of an agent may include, e.g., the agent's problem-solving proficiency with respect to different issues, behavioral skills, and sales quotient, each of which may also be divided into different specific skill evaluations. The current dynamics of the agent may be evaluated separately also by leveraging AI-enabled models based on, e.g., current communication data to assess the agent's current state (e.g., the mental and physical) which may be relevant to how the agent is going to be matched with appropriate customers. As illustrated in FIG. 1B, an agent's current dynamics may be assessed with respect to the exhaustion level, customer satisfaction level, and the complexity level of the tasks recently handled.

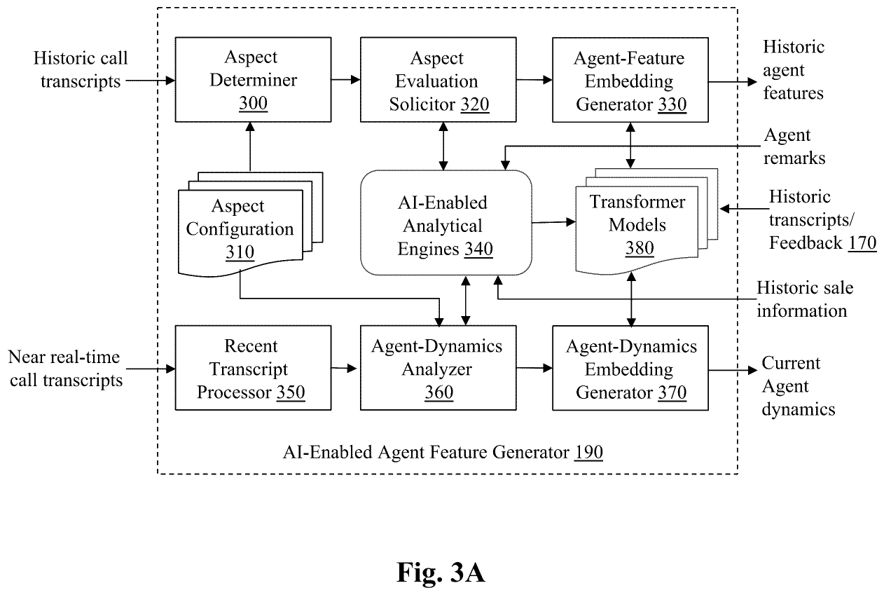

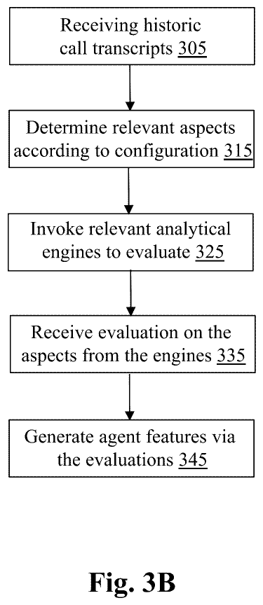

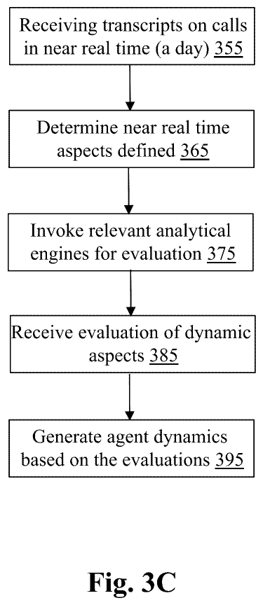

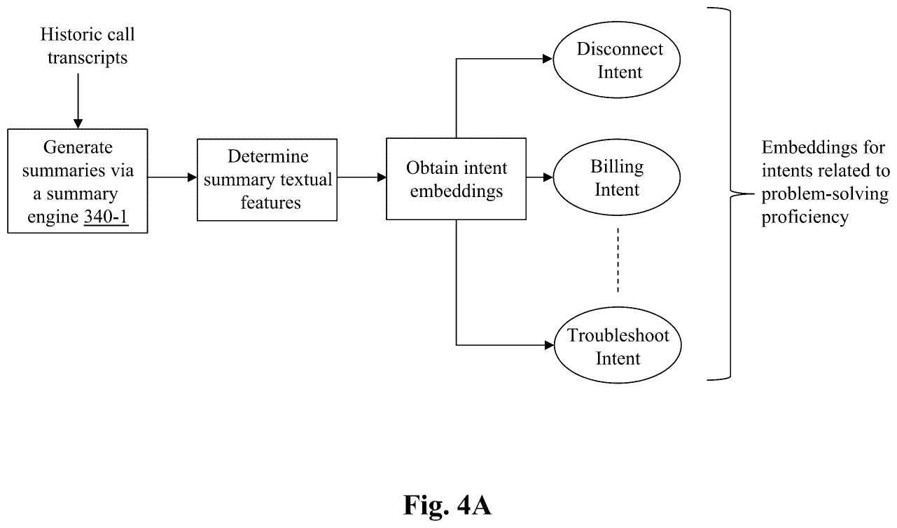

As discussed herein, features characterizing each agent may be obtained via AI-enabled models based on content of past and current conversations between an agent and customers. Such content may be from textual conversations or from transcripts of voice communications provided by the transcript generator 160. Such textual information is provided to the AI-enabled agent feature generator 190 to derive agent features in accordance with the present teaching. In some embodiments, feedback 170 on agents received from, e.g., qualified or authorized sources, may also be used in determining agent's features. Once obtained, such features may be stored in the agent database 150-1 to facilitate the customer-agent matching engine 140 to match an agent with a customer on a call related to a certain issue. When additional transcripts are available, agents'features may be updated based on new data. Details about the operation of the AI-enabled agent feature generator 190 are provided below with reference to FIG. 3A-5B.

The agent assessment engine 180 may be optionally provided to derive an assessment of agents based on, e.g., the agents'features. In some embodiments, the agent assessment engine 180 may also assess based on feedback 170. Such assessment may for each agent may include an overall evaluation, an evaluation with respect to each issue, an evaluation on behavioral skills, and an evaluation on agent's ability to upsell, etc. The assessment may also include ranking of all agents on, e.g., issues, behavioral skills, ability to upsell, etc. Besides agent features, the categorical assessment on agents produced by the agent assessment engine 180 may provide additional information to the customer-agent matching engine 130 to identify a most suitable pairing in each situation.

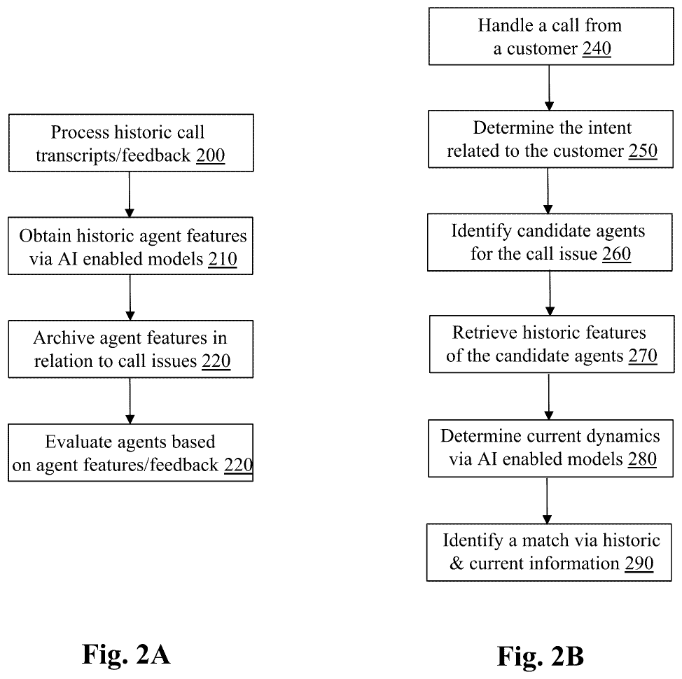

FIG. 2A is a flowchart of an exemplary process of obtaining historic agent features via AI-enabled models based on historic communication records, in accordance with an embodiment of the present teaching. This part of the operation corresponds to the backend operation of the framework 100, which creates information based on historic transcripts/feedback to derive agent features and assessment thereof. In the backend operation, based on transcripts from historic conversations, the gen-AI based agent feature generator 190 processes, at 200, the historic transcripts and optionally the feedback 170 and obtains, at 210, agent features via AI-enabled models according to the present teaching. The obtained agents'features and optionally the feedback 170 are utilized by the agent assessment engine 180 to evaluate, at 220, the agents. Both the agents'features, and the assessment thereof are then archived, at 230, in the agent database 150-1.

FIG. 2B is a flowchart of an exemplary process of identifying a matching agent based on both historic features and current dynamics of the agent determined via generative-AI, in accordance with an embodiment of the present teaching. This part of the operation corresponds to the frontend process of framework 100, which takes a call from a customer on an identified issue and matches the customer with a suitable agent based on agents'features and assessment thereof from historic data as well as the current dynamics of the agents. In operation, the call assessment unit 130 handles, at 240, a call from a customer and determines, at 250, the intent associated with the call and forwards the information to the customer-agent matching engine 140. To find a match, the customer-agent matching engine 140 identifies, at 260, candidate agents who are assessed as capable of handling the call issue based on, e.g., the assessment of agents per different issues. With respect to the candidate agents for the call issue, their historic features derived via generative-AI are retrieved, at 270, from the agent database 150-1. With respect to each candidate agents, the transcripts of customer communications involving the candidate agent in a near real-time timeframe (e.g., a day) may be used to determine, at 280, the current dynamics of the candidate agent. Based on both historic features and the current dynamics of the candidate agents, a matching agent is identified at 290.

As discussed herein, in the exemplary framework 100, pairing is identified based on characterization of agents, obtained via AI-enabled models, including both agents'historic features as well as their performance dynamics in a near real-time period. Both historic and current agents'evaluation are obtained by the AI-enabled agent feature generator 190. FIG. 3A depicts an exemplary high level system diagram of the AI-enabled agent feature detector 190, in accordance with an embodiment of the present teaching. In this illustrated embodiment, there are two parts, one for determining the historic agent features based on transcripts of historic communications between agents and customers and the other for assessing agents'current dynamics based on transcripts of near real-time communications between agents and customers. Both parts obtain characterization of agents via a collection of AI-enabled analytical engines 340 and transformer models 380 trained based on assessments on different aspects of performance by different AI-enabled analytical engines. The first part includes an aspect determiner 300, an aspect evaluation solicitor 320, and an agent-feature embedding generator 330. The second part includes a recent transcript processor 350, an agent-dynamic analyzer 360, and an agent-dynamics embedding generator 370.

FIG. 3B is a flowchart of an exemplary process of the first part of the AI-enabled agent feature generator 190 for generating historic agent features, in accordance with an embodiment of the present teaching. In operation, when historic call transcripts are received at 305, the aspect determiner 300 may access a configuration 310 that specifies different aspects and sub-aspects thereof of agent performance to be evaluated. In some embodiments, the configuration 310 may provide specification of evaluation aspects of both historic agent features and current agent dynamics. Based on the configuration 310, aspects to be assessed for historic agent features are determined at 315. For example, the configured aspects may include problem-solving proficiency, behavioral/communication skills, and sale quotient. The configuration 310 may further define sub-aspects associated with each aspect. For instance, it may define that the problem-solving proficiency may be evaluated with respect to several sub-aspects to include, e.g., proficiency at each issue from customers (e.g., issues on billing, service disconnect, trouble shooting, etc.). The behavioral/communication skill may be assessed in terms of sub-aspects on patience/empathy, call style/effectiveness, code-switching abilities, and the ability to comply with policies, etc. An agent's sale quotient may be assessed by evaluating sub-aspects of an agent's performance, including negotiation skills, upselling ability, cross-selling ability, personalization, and the historic sales made, etc.

Depending on the aspects/sub-aspects specified according to configuration 310, the aspect evaluation solicitor 320 may invoke, at 325, corresponding analytical engines in the collection of AI-enabled analytical engines 340 directed to the aspects/sub-aspects and receives, at 335, respective assessment from the invoked analytical engines derived based on the input historic transcripts. Such assessments from different analytical engines are then used by the agent-feature embedding generator 330 to generate, at 345, historic agent features based on transformer models 380.

FIG. 3C is a flowchart of an exemplary process of the second part of the AI-enabled agent feature generator 190 for evaluating current dynamics of an agent via generative-AI, in accordance with an embodiment of the present teaching. In operation, when the AI-enabled agent feature generator 190 is invoked to assess an agent's current dynamics, the recent transcript processor 350 receives, at 355, transcripts on communications occurred during a near real-time period and processes the received transcripts. To assess the current dynamics of an agent, the agent-dynamics analyzer 360 determines, at 365, the aspects/sub-aspects of performance to be evaluated to derive the current dynamics of the agent according to, e.g., the specification provided in the configuration 310. For instance, while an agent's historic features may have been estimated based on historic data, the near real-time dynamics of an agent may be assessed with different considerations, including the emotional state of the agent, the level of exhaustion of the agent, the level of satisfaction of the customers interacted with the agent in near real-time period, and other factors.

Based on the processed current transcripts and the aspects/sub-aspects to be assessed for agent's current dynamics, the agent-dynamics analyzer 360 then invokes, at 375, corresponding analytical engines with the current transcripts to obtain, at 385, assessment on these aspects/sub-aspects. For example, in some embodiments, based on transcripts of near real-time communications, the agent's dynamics may be assessed, using invoked engines in the analytical engines 340 based on the near real time transcripts, with respect to some aspects reflecting the current state of the agent such as the exhaustion level, the emotional state, the level of complexity of the matters recently handled, as well as the level of customer satisfaction. Based on such assessments in different aspects/sub-aspects, the agent-dynamics embedding generator 370 generates, at 395, embeddings representing the estimated current dynamics of the agent based on the transformer models 380.

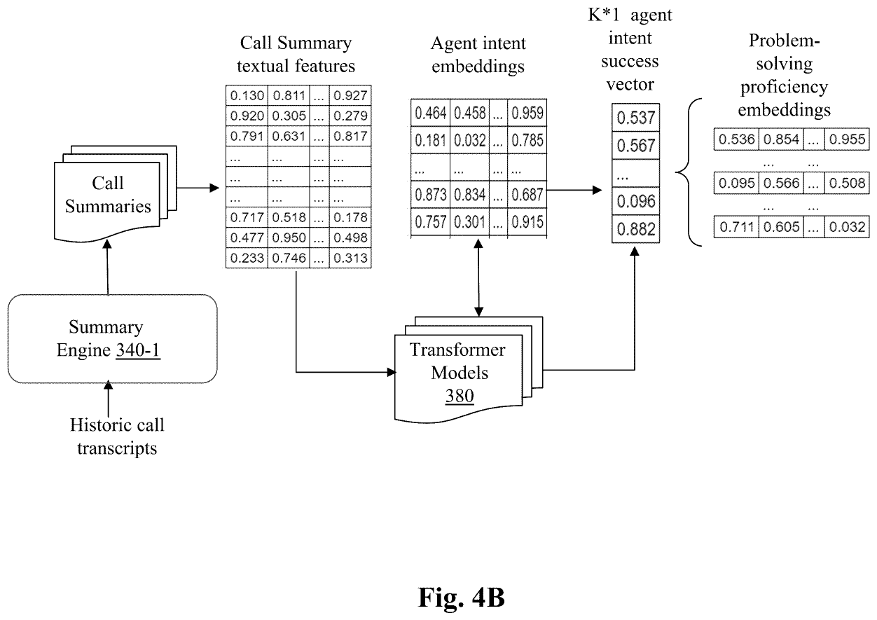

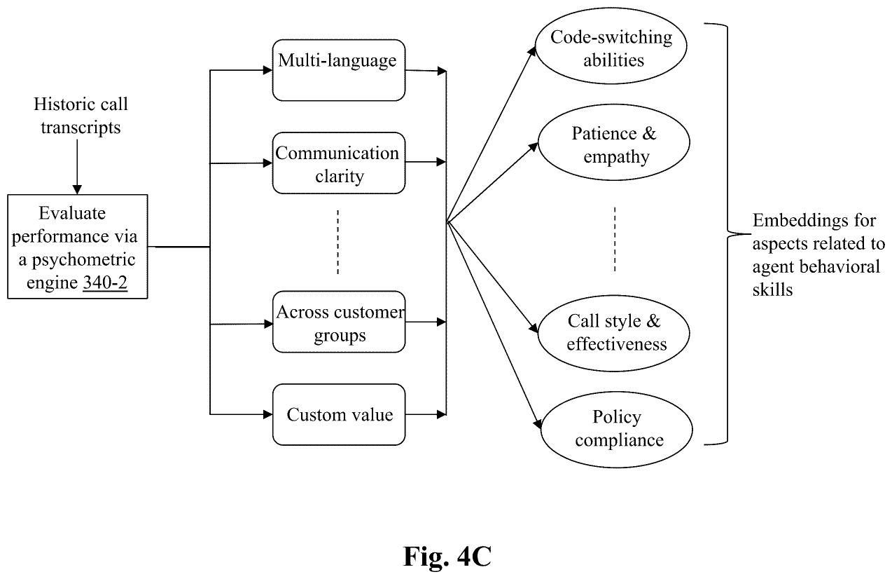

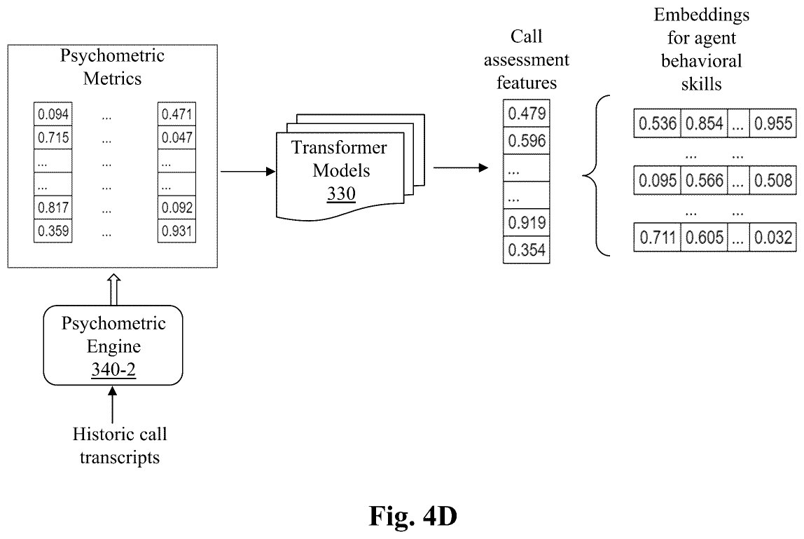

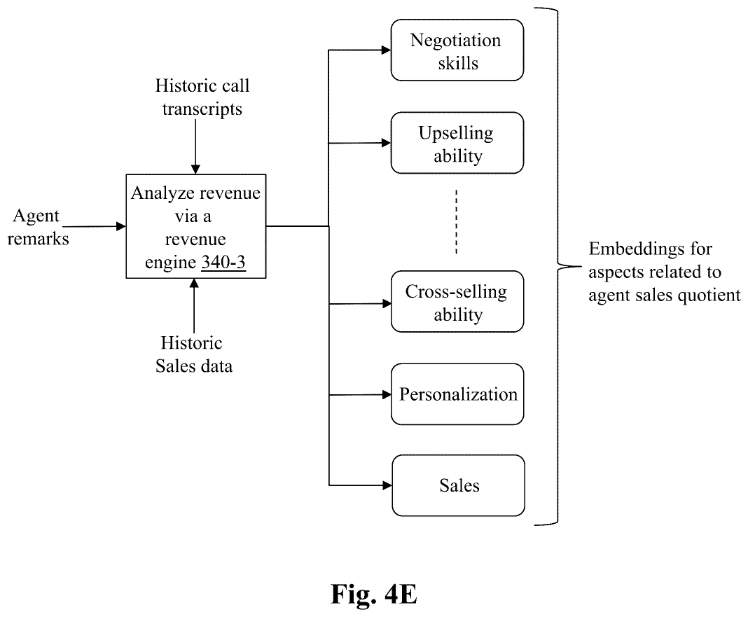

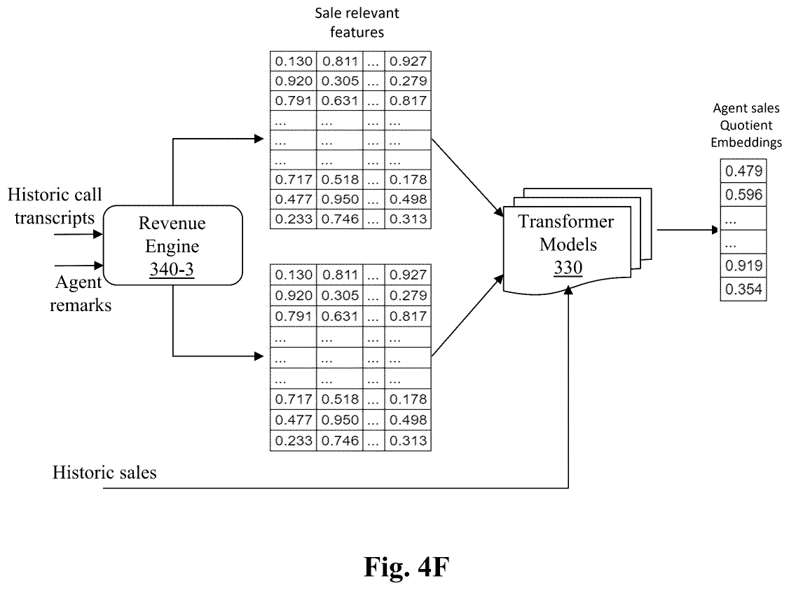

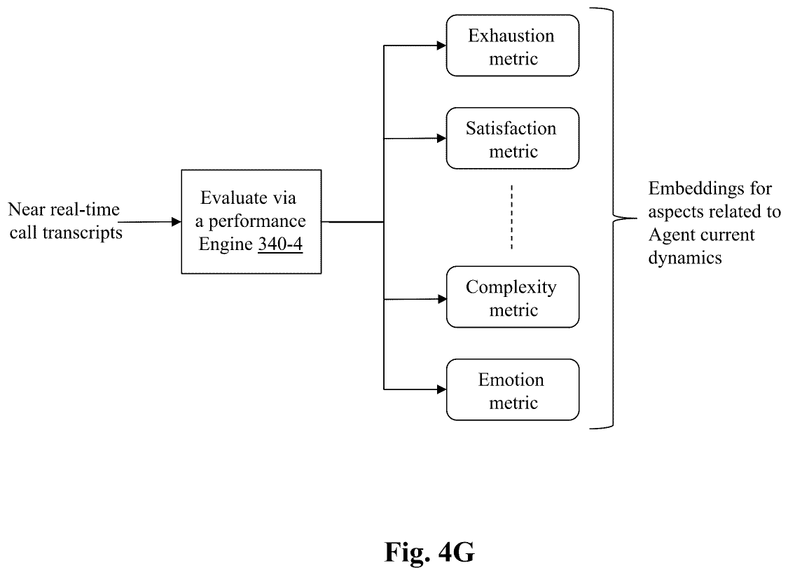

The operations of different parts of the AI-enabled agent feature generator 190 are illustrated in FIG. 4A-4G with respect to features directed to different aspects of agent's performance using the example application in customer-agent pairing. FIG. 4A depicts a flow of operation to obtain embeddings representing an agent's historic problem-solving proficiency, in accordance with an embodiment of the present teaching. When transcripts for historic calls involving an agent are received, a summary engine 340-1 (included in the AI-enabled analytical engines 340) may be invoked to generate summaries for such calls and textual features may be extracted from the summaries. The summary engine 340-1 may be provided as an AI-enabled model trained to create a summary of a text input. In some embodiments, the summary engine 340-1 may correspond to a language model (which may be an LLM or an SLM) trained for the specific task of summary creation. Textual features extracted from summaries may be used to group the summaries into clusters directed to different intents. For instance, some calls may be for billing issues, troubleshoot related issues, or network disconnect related problems. Call summaries associated with each specific intent may then be used to generate intent embeddings representing the historic agent's performance with respect to the that intent. As illustrated, intent embeddings may be created based on historic data with respect to disconnect intent, billing intent, troubleshoot intent, or the like. These embeddings associated with various intents may be used individually when assessing whether the agent is suitable to handle a call with a specific intent. In some implementations, these embeddings may also be combined to create integrated embeddings to represent the agent's historic problem-solving proficiency as shown in FIG. 4A.

This is further illustrated using some exemplary data in FIG. 4B, which offers an example of obtaining embeddings characterizing an agent's problem-solving proficiency, in accordance with an embodiment of the present teaching. As shown, the summaries for calls involving an agent are generated by the summary engine 340-1 based on historic call transcripts. Textual features (feature vectors) may be extracted from such summaries as shown in FIG. 4B. In this example, each row of call summary textual features may correspond to a feature vector with features extracted from a summary. These feature vectors for different call summaries may then be used to map to embeddings with respect to different intents representing assessment of an agent's ability to handle a corresponding customer intent or issue.

In some embodiments, the mapping from textual features of call summaries to embeddings representing assessment on agent with respect to different intents may correspond to data transformation at different stages, which may be carried out by, e.g., transformer models 380, as illustrated in FIG. 4B. Each transformer model in 380 may be trained for carrying out a designated type of transformation. For example, a transformation model may be provided for mapping from textural features for call summaries to intent embeddings with respect to different intents. To derive embeddings representing the agent's proficiency in resolving a specific intent, intent embeddings for the agent may be integrated, e.g., via a different transformer model from the transformer models 380, to generate an agent intent success vector indicative of the agent's proficiency in resolving issues associated with that intent. For instance, there may be multiple summaries associated with the same intent and their embeddings may be the basis for the transformer model to generate an agent intent success vector associated with the intent. In some embodiments, the intent success vectors of an agent across different intents may be further combined to generate, via e.g., another transformer model from 380, embeddings of the agent indicative of the agent's overall problem-solving proficiency.

Different transformer models in 380 may be trained for some designated transformation and may be implemented using different AI models suitable for transformations at different stages of the processing. As shown, a transformer model may be used to map textual features extracted from call summaries to agent's intent embeddings, as shown in FIG. 4B. Another stage of transformation may be from agent intent embeddings to an intent success vector summarizing the success across different intents. Yet another stage of transformation may be from different intent success vectors to embeddings characterizing the agent's problem-solving proficiency. These transformations may be carried out via the collective transformer models 380, each of which may be obtained via machine learning. Models at different stages may be adopted suitable for the designated operation. For instance, a multi-layer perceptron model may be used for the mapping from texture features to intent embeddings, while a mixture of experts (MoE) model may be employed for mapping from agent's intent embeddings to an agent's success vector. Depending on the nature of transformation needed at each stage, any appropriate models, presently existing or developed in the future, may be deployed and trained to enable the transformation needed.

FIG. 4C depicts a flow of operation to obtain embeddings representing an agent's behavioral skills, in accordance with an embodiment of the present teaching. When transcripts of historic calls involving an agent are received, a psychometric engine 340-2 within the collective AI-enabled analytical engines 340 may be invoked to generate metrics characterizing various sub-aspects associated with the agent's behavioral skills, including, e.g., a metric indicating whether the agent is multi-lingual, some metric(s) indicating whether the agent presented communication clarity in historical calls, metric(s) indicating whether the agent demonstrated the ability of cross customer groups, and metric(s) evaluating whether the agent presented custom value, etc. Such psychometrics from the psychometric engine 340-2 may be used by transformer models 380 as input to generate embeddings representing different sub-aspects related to the agent's behavioral skills. For instance, the psychometrics generated by the psychometric engine 340-2 may be used to assess the agent's patience, empathy, code-switching abilities, the agent's call style and effectiveness, and the agent's ability to comply with policies. These embeddings characterize sub-aspects of the agent's skills in behavior and mannerism in communicating with customers. In some implementations, these embeddings representing different sub-aspects of behavioral skills may also be integrated to reach an overall evaluation on an agent's communication skills, as shown in FIG. 4C. It is noted that the transformer models 380 may also include models trained for deriving embeddings characterizing an agent's behavioral skills or sub-aspects thereof may differ from that used for deriving representations for an agent's problem-solving proficiency.

Reaching evaluations on an agent on behavioral skills may be further illustrated with specific exemplary data in FIG. 4D, which offers an example of obtaining embeddings characterizing an agent's behavioral skills, in accordance with an embodiment of the present teaching. As shown, the historic call transcripts are provided as input to the psychometric engine 340-2, which determines various psychometrics directed to different sub-aspects associated with behavioral skills as shown in FIG. 4D. In this illustration, with respect to each call, various psychometrics are generated as a feature vector. The feature vectors for different calls may then be used, by an appropriate transformer model in the transformer models 380 trained to map these feature vectors on psychometrics to call assessment features directed to each of sub-aspects (e.g., patience, empathy, code-switching ability, ...) associated with behavioral skills, as shown on the right of FIG. 4D. In some embodiments, embeddings for different sub-aspects may also be integrated to create a combined embedding characterizing the overall behavioral skill of the agent.

FIG. 4E depicts a flow of operation to obtain embeddings representing an agent's sale quotient, in accordance with an embodiment of the present teaching. The sale quotient of an agent indicates the ability of the agent to take the communication with customers as an opportunity to successfully sell additional services and may be exhibited during communications with customers and may be evaluated with respect to different qualities or sub-aspects, such as negotiation skills, upselling capability, cross-selling ability, the ability of personalizing across different customers, and the actual sales made. Based on information from different sources, a revenue engine 340-3 (within the analytical engine 340) may be invoked to produce evaluations in different sub-aspects related to an agent's sale quotient. In addition to the historic call transcripts and sales data, agent remarks associated with the agent may also be provided to the revenue engine 340-3 to produce evaluations (e.g., as features such as embeddings) with respect to exemplary sub-aspects associated with agent's sale quotient.

FIG. 4F shows an example of obtaining embeddings characterizing an agent's sale quotient, in accordance with an embodiment of the present teaching. As illustrated, the historic call transcripts and agent remarks are provided as input to the revenue engine 340-3, which output various sale relevant features for each call based on the call transcript and agent remarks, as shown in FIG. 4F. As discussed herein, the features from the revenue engine 340-3 may characterize some sub-aspects as discussed with reference to FIG. 4E such as negotiation skills, the ability of upselling, cross-selling, and personalizing. Each of these sub-aspects may be represented by a feature vector as illustrated in FIG. 4F. Such feature vectors representing evaluation on different sub-aspects of sale quotient (captured from different calls of the same agent) may then be used in mapping, by appropriate transformer model in the transformer models 380 to embeddings characterizing the agent's sale quotient, as illustrated on the right of FIG. 4F. During the transformation, the historic sales data associated with the agent during the calls may also be provided as an input to the transformer model. In some embodiments, such embeddings may represent the overall evaluation of the agent's sale quotient.

As discussed herein, in addition to obtaining embeddings, via different analytical engines 340 and appropriate machine trained transformer models 380 (both trained based on historic call transcripts via, e.g., supervised learning), to characterize an agent's historic performance with respect to different aspects of performance, the AI-enabled agent feature generator 190 also includes the second part for assessing the agent's current dynamics. This is achieved based on transcripts of communications of the agent in a near real-time period. FIG. 4G depicts an exemplary flow of operation of the second part to obtain embeddings representing an agent's current dynamics, in accordance with an embodiment of the present teaching. When near real-time call transcripts associated with an agent are received, a performance evaluation engine 34-0-4 may be invoked to assess the agent's current dynamics based on the near real-time call transcripts.

As discussed herein with reference to FIG. 3A, the dynamics to be evaluated of an agent's current performance may be specified in configuration 310. In some embodiments, such dynamics to be evaluated may include, as illustrated in FIG. 4G, whether the agent appears to be exhausted, the current emotional state of the agent, the level of complexity of the issues handled in the near real-time period, and the recent customer satisfaction detected from the input near real-time transcripts. Such assessment in different aspects output from the performance engine 340-4 may then be used as input to machine trained transformers (included in the transformer models 380) to map to embeddings characterizing an agent's current dynamics with respect to different aspects.

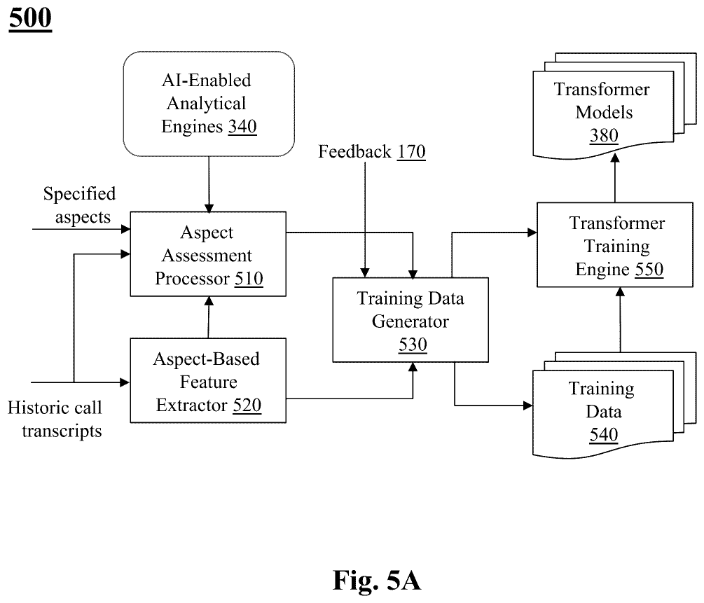

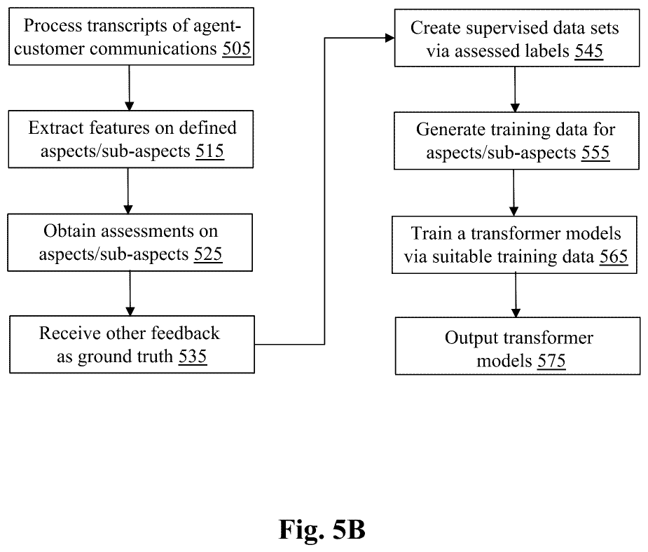

As discussed herein, both the first and second parts of the AI-enabled agent feature generator 190 for obtaining historic agent features and agent's current dynamics may rely on appropriately trained transformer models 380. FIG. 5A depicts an exemplary high level system diagram of an exemplary scheme 500 to obtain transformer models 380 via machine learning, in accordance with an embodiment of the present teaching. This illustrated scheme 500 comprises an aspect assessment processor 510, an aspect-based feature extractor 520, a training data generator 530, and a transformer training engine 550. In this illustrated scheme 500, the AI-enabled analytical engines 340 with AI models trained to derive assessments of different aspects of an agent performance may be leveraged so that the evaluation from different analytical engines may be used as ground truth on agents'performance to create supervised training data for machine learning. In some embodiments, additional input may also be incorporated as part of the ground truth in creating automatically supervised training data. For instance, feedback 170 from other sources (e.g., managerial personnel authorized to evaluate agents or feedback from customers) may be obtained and combined with assessments on different aspects of agent performance from different analytical engines 340 to generate supervised data sets for corresponding aspects/sub-aspects thereof to enable machine learning of different transformers.

FIG. 5B is a flowchart of an exemplary process for obtaining transformer models 380 based on AI-enabled analytical engines, in accordance with an embodiment of the present teaching. In operation, transcripts of agent-customer communications (may be historic or near real-time communications) are received and processed, at 505, to extract, at 515, features associated with different aspects and sub-aspects associated with agent performance. In the meantime, the historic transcripts may be provided to the aspect assessment processor 510 which may invoke relevant analytical engines (in the AI-enabled analytical engines 340) to obtain, at 525, assessment on specified aspects/sub-aspects of agent performance. According to the exemplary machine learning scheme 500 as discussed herein, such assessments from AI-enabled analytical engines 340 may be used as the ground truth of agent performance evaluation. Such automatically ground truth obtained via AI-enabled analytical engines may be used to facilitate supervised learning of transformer models 380.

In some embodiments, optionally, feedback from other sources may also be used, at 535, as ground truth in creating supervised training data sets with respect to corresponding aspects or sub-aspects. For example, a manager for agents may provide evaluation on some aspects of agents'performance or on the overall ranking of agents in some area such as agents'cross-selling abilities. Such feedback may be utilized as ground truth in creating labeled data sets. Based on features extracted from transcripts and ground truth assessment of performance from AI-enabled analytical engines 340 in different aspects, supervised data sets may be created at 545. In some embodiments, depending on the configuration of aspects/sub-aspects or operational needs for different transformers, training data for training different transformer for different purposes may be separately created at 555 and used to train, at 565, different transformer models via machine learning. The trained transformer models 380 are then output, at 575, to facilitate the automated AI-enabled performance evaluation according to the present teaching.

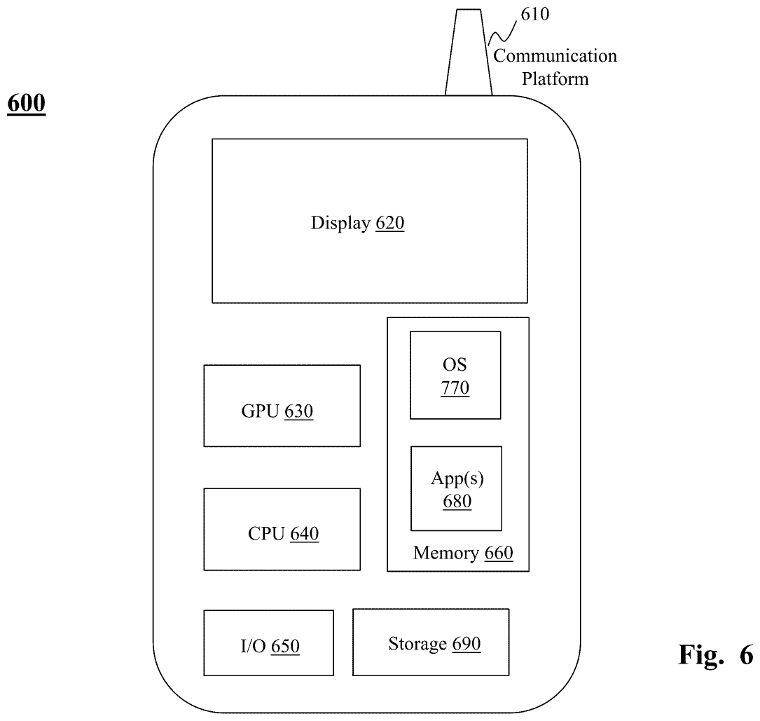

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

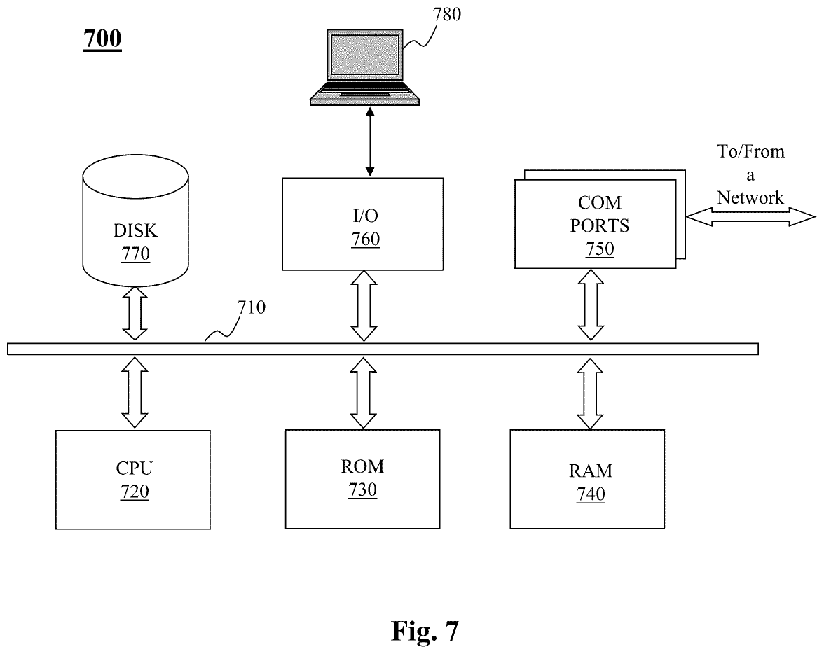

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving transcripts of historic communications between a plurality of agents and a plurality of customers;
obtaining an assessment from at least one artificial intelligence (AI)-enabled analytical engine with respect to one or more aspects of historic performance of each of the plurality of agents based on the transcripts of historic communications;
generating historic agent features for each of the plurality of agents, via transformer models trained via machine learning based on the assessment;
receiving a request relating to a new communication;
determining an intent of the new communication;
identifying one or more of the plurality of agents as candidate agents according to the intent and the historic agent features of the candidate agents;
determining current dynamics of each of the one or more candidate agents;
identifying a matching agent from the candidate agents based on the historic agent features and the current dynamics of the candidate agents; and
directing the new communication to the matching agent to carry on the new communication.

2. The method of claim 1, wherein the one or more aspects of historic performance of an agent include at least one of:
problem-solving proficiency of the agent revealed in the historic communications;
behavioral skill of the agent exhibited in the historic communications; and
sale quotient relating to the agent's ability of making sales in the historic communications.

3. The method of claim 2, wherein the obtaining assessment with respect to the problem-solving proficiency aspect of agent performance comprises:
generating, via a summary engine, a summary for each of the transcripts of the historic communications;
determining textual features of each summary generated by the summary engine;
generating intent embeddings associated with each intent involving each of the plurality of agents;
creating agent intent success vectors for the plurality of agents; and
obtaining embeddings for each of the plurality of agents to represent the problem-solving proficiency of the agent.

4. The method of claim 2, wherein the obtaining assessment with respect to the behavioral skill aspect of agent performance comprises:
obtaining, from a psychometric engine, one or more psychometrics based on each of the transcripts of the historic communications;
deriving, via transformer models based on the one or more psychometrics, assessment features relating to the behavioral skill aspect exhibited in each of the historic communications involving each of the plurality of agents; and
obtaining embeddings for each of the plurality of agents based on the assessment features to represent the behavioral skills of the agent.

5. The method of claim 2, wherein the obtaining assessment with respect to the sales quotient of agent performance comprises:
obtaining, from a revenue engine, a plurality of sale relevant features based on each of the transcripts of the historic communications;
deriving, via transformer models based on the plurality of sale relevant features, embeddings for each of the plurality of agents based on the plurality of sale relevant features to represent the sales quotient of the agent.

6. The method of claim 1, wherein the step of determining current dynamics of each of the candidate agents comprises:
receiving near real-time transcripts associated with the candidate agent;
obtaining, from a performance engine, a plurality of assessment indicators based on each of the near real-time transcripts involving the candidate agent;
deriving, via transformer models based on the plurality of assessment indicators, embeddings for the agent representing current dynamics of the agent.

7. The method of claim 1, wherein the transformer models are obtained via machine learning based on training data generated via AI-enabled analytical models, comprising:
processing the transcripts of the historic communications to extract features related to different aspects of agent performance and/or sub-aspects thereof;
obtaining assessments, from one or more AI-enabled analytical engines, directed to the different aspects of agent performance and the sub-aspects thereof;
generating, based on the features extracted and assessments from the one or more AI-enabled analytical engines, supervised training data sets for each of the different aspects and/or the sub-aspects thereof;
performing machine learning of the transformer models corresponding to the aspects and/or sub-aspects thereof based on respective training data sets; and
generating the transformer models based on the machine learning result.

8. A machine-readable and non-transitory medium having information recorded thereon, wherein the information, when read by the machine, causes the machine to perform the following steps:
receiving transcripts of historic communications between a plurality of agents and a plurality of customers;
obtaining an assessment from at least one artificial intelligence (AI)-enabled analytical engine with respect to one or more aspects of historic performance of each of the plurality of agents based on the transcripts of historic communications;
generating historic agent features for each of the plurality of agents, via transformer models trained via machine learning based on the assessment;
receiving a request relating to a new communication;
determining an intent of the new communication;
identifying one or more of the plurality of agents as candidate agents according to the intent and the historic agent features of the candidate agents;
determining current dynamics of each of the one or more candidate agents;
identifying a matching agent from the candidate agents based on the historic agent features and the current dynamics of the candidate agents; and
directing the new communication to the matching agent to carry on the new communication.

9. The medium of claim 8, wherein the one or more aspects of historic performance of an agent include at least one of:
problem-solving proficiency of the agent revealed in the historic communications;
behavioral skill of the agent exhibited in the historic communications; and
sale quotient relating to the agent's ability of making sales in the historic communications.

10. The medium of claim 9, wherein the obtaining assessment with respect to the problem-solving proficiency aspect of agent performance comprises:
generating, via a summary engine, a summary for each of the transcripts of the historic communications;
determining textual features of each summary generated by the summary engine;
generating intent embeddings associated with each intent involving each of the plurality of agents;
creating agent intent success vectors for the plurality of agents; and
obtaining embeddings for each of the plurality of agents to represent the problem-solving proficiency of the agent.

11. The medium of claim 9, wherein the obtaining assessment with respect to the behavioral skill aspect of agent performance comprises:
obtaining, from a psychometric engine, one or more psychometrics based on each of the transcripts of the historic communications;
deriving, via transformer models based on the one or more psychometrics, assessment features relating to the behavioral skill aspect exhibited in each of the historic communications involving each of the plurality of agents; and
obtaining embeddings for each of the plurality of agents based on the assessment features to represent the behavioral skills of the agent.

12. The medium of claim 9, wherein the obtaining assessment with respect to the sales quotient of agent performance comprises:
obtaining, from a revenue engine, a plurality of sale relevant features based on each of the transcripts of the historic communications;
deriving, via transformer models based on the plurality of sale relevant features, embeddings for each of the plurality of agents based on the plurality of sale relevant features to represent the sales quotient of the agent.

13. The medium of claim 8, wherein the step of determining current dynamics of each of the candidate agents comprises:
receiving near real-time transcripts associated with the candidate agent;
obtaining, from a performance engine, a plurality of assessment indicators based on each of the near real-time transcripts involving the candidate agent;
deriving, via transformer models based on the plurality of assessment indicators, embeddings for the agent representing current dynamics of the agent.

14. The medium of claim 8, wherein the transformer models are obtained via machine learning based on training data generated via AI-enabled analytical models, comprising:
processing the transcripts of the historic communications to extract features related to different aspects of agent performance and/or sub-aspects thereof;
obtaining assessments, from one or more AI-enabled analytical engines, directed to the different aspects of agent performance and the sub-aspects thereof;
generating, based on the features extracted and assessments from the one or more AI-enabled analytical engines, supervised training data sets for each of the different aspects and/or the sub-aspects thereof;
performing machine learning of the transformer models corresponding to the aspects and/or sub-aspects thereof based on respective training data sets; and
generating the transformer models based on the machine learning result.

15. A system, comprising:
an artificial intelligence (AI)-enabled agent feature generator implemented using a processor and configured for
receiving transcripts of historic communications between a plurality of agents and a plurality of customers,
obtaining an assessment from at least one AI-enabled analytical engine with respect to one or more aspects of historic performance of each of the plurality of agents based on the transcripts of historic communications, and
generating historic agent features for each of the plurality of agents, via transformer models trained via machine learning based on the assessment; and
a customer-agent matching engine implemented using a processor and configured for
receiving a request relating to a new communication,
determining an intent of the new communication,
identifying one or more of the plurality of agents as candidate agents according to the intent and the historic agent features of the candidate agents,
determining current dynamics of each of the one or more candidate agents,
identifying a matching agent from the candidate agents based on the historic agent features and the current dynamics of the candidate agents, and
directing the new communication to the matching agent to carry on the new communication.

16. The system of claim 15, wherein the one or more aspects of historic performance of an agent include at least one of:
problem-solving proficiency of the agent revealed in the historic communications;
behavioral skill of the agent exhibited in the historic communications; and
sale quotient relating to the agent's ability of making sales in the historic communications.

17. The system of claim 16, wherein the obtaining assessment with respect to the problem-solving proficiency aspect of agent performance comprises:
generating, via a summary engine, a summary for each of the transcripts of the historic communications;
determining textual features of each summary generated by the summary engine;
generating intent embeddings associated with each intent involving each of the plurality of agents;
creating agent intent success vectors for the plurality of agents; and
obtaining embeddings for each of the plurality of agents to represent the problem-solving proficiency of the agent.

18. The system of claim 16, wherein the obtaining assessment with respect to the behavioral skill aspect of agent performance comprises:
obtaining, from a psychometric engine, one or more psychometrics based on each of the transcripts of the historic communications;
deriving, via transformer models based on the one or more psychometrics, assessment features relating to the behavioral skill aspect exhibited in each of the historic communications involving each of the plurality of agents; and
obtaining embeddings for each of the plurality of agents based on the assessment features to represent the behavioral skills of the agent.

19. The system of claim 16, wherein the obtaining assessment with respect to the sales quotient of agent performance comprises:
obtaining, from a revenue engine, a plurality of sale relevant features based on each of the transcripts of the historic communications;
deriving, via transformer models based on the plurality of sale relevant features, embeddings for each of the plurality of agents based on the plurality of sale relevant features to represent the sales quotient of the agent.

20. The system of claim 15, wherein the step of determining current dynamics of each of the candidate agents comprises:
receiving near real-time transcripts associated with the candidate agent;
obtaining, from a performance engine, a plurality of assessment indicators based on each of the near real-time transcripts involving the candidate agent;
deriving, via transformer models based on the plurality of assessment indicators, embeddings for the agent representing current dynamics of the agent.
